(19) United States
(12) Patent Application Publication
(10) Pub. No.: US 2020/0291624 A1
(43) Pub. Date: Sep. 17, 2020

(54) EMERGENCY BACKFLOW PREVENTING SYSTEM

(71) Applicants: James T. Reese, Nibley, UT (US); Ronald Lee White, Hyde Park, UT (US)

(72) Inventors: James T. Reese, Nibley, UT (US); Ronald Lee White, Hyde Park, UT (US)

(21) Appl. No.: 16/810,540

(22) Filed: Mar. 5, 2020

Related U.S. Application Data
(60) Provisional application No. 62/817,218, filed on Mar. 12, 2019.

(51) Int. Cl. E03B 7/07; E03C 1/10; E03F 7/04; E03F 5/042; F16K 7/10

(52) U.S. Cl. CPC E03B 7/077; E03C 1/104; F16K 7/10; E03F 5/042; E03F 7/04

(57) ABSTRACT

In an exemplary embodiment, an emergency backflow preventing system is disclosed that includes an inflatable bladder, an air supply line demountably coupled to the inflatable bladder, a valve demountably coupled to the air supply line, and an air source functionally coupled to the valve. The inflatable bladder includes a deflated state and an inflated state and is substantially void of air in the deflated state. The inflatable bladder is configured to be inserted within a sewage pipe when in the deflated state. The inflatable bladder is configured to contact a bore of the sewage pipe when in the inflated state and thereby wedge itself within the sewage pipe. The inflatable bladder comprises an elastic polymer. The valve comprises a Schrader valve and an air pressure gauge. A cable is positioned within the air supply line and is anchored within the valve and the inflatable bladder.

### CROSS-REFERENCE TO RELATED APPLICATIONS

This application claims priority to U.S. Provisional Application No. 62/817,218 filed Mar. 12, 2019, which is hereby incorporated herein by reference.

### FIELD OF THE INVENTION

The present disclosure relates generally to sewer backflow. More specifically, the present disclosure describes emergency backflow preventing system.

### BACKGROUND OF THE INVENTION

During hurricanes, storm surges, rainstorms, floods and similar meteorological emergencies that typically result in the introduction of high volumes of liquid into the environment, sewer systems can become overwhelmed and backed up, which causes wastewater to flow back through the pipes into homes and businesses (hereinafter “backflow”). Backflow can cause costly damage and result in serious health concerns (e.g., black mold).

### BRIEF DESCRIPTION OF THE DRAWINGS

Some of the embodiments will be described in detail, with reference to the following figures, wherein like designations denote like members, wherein:

FIG. 1 depicts block diagram of an emergency backflow preventing system, according to some embodiments.

FIG. 2 illustrates a valve coupled to an air supply line, according to other embodiments.

FIGS. 3A and 3B illustrates an air supply line traversing a sewer clean out pipe, according to certain embodiments.

FIG. 4 illustrates the air supply line and a cable, according to yet still others embodiments.

FIG. 5 illustrates a side view of an inflatable bladder, according to some embodiments.

FIG. 6 illustrates a cut-through view of the inflatable bladder along axis 5 of FIG. 5, according to other embodiments.

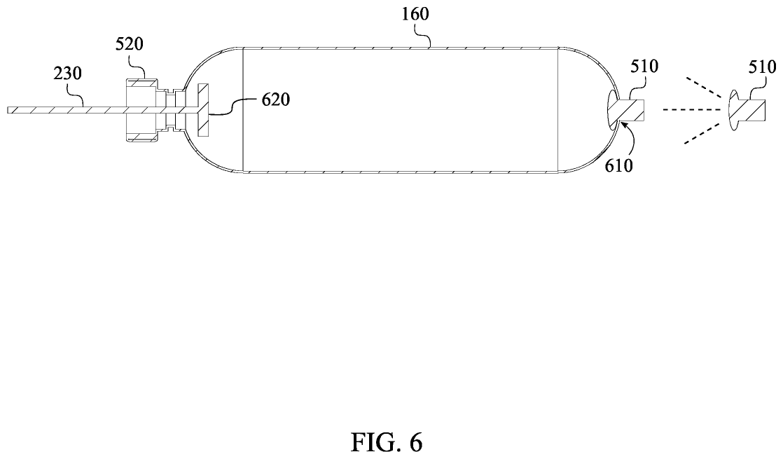

FIG. 7 illustrates an assembled emergency backflow preventing system, according to certain embodiments.

FIG. 8 illustrates a partial underground public utility view of a building, according to yet still others embodiments.

FIG. 9 illustrates view 9 of FIG. 8, according to some embodiments.

FIG. 10 illustrates the inflatable bladder inserted in a sewer lateral in its “deflated state”, according to certain embodiments.

FIG. 11 illustrates the inflatable bladder in its “inflated state” while positioned within the sewer lateral 810, according to other embodiments.

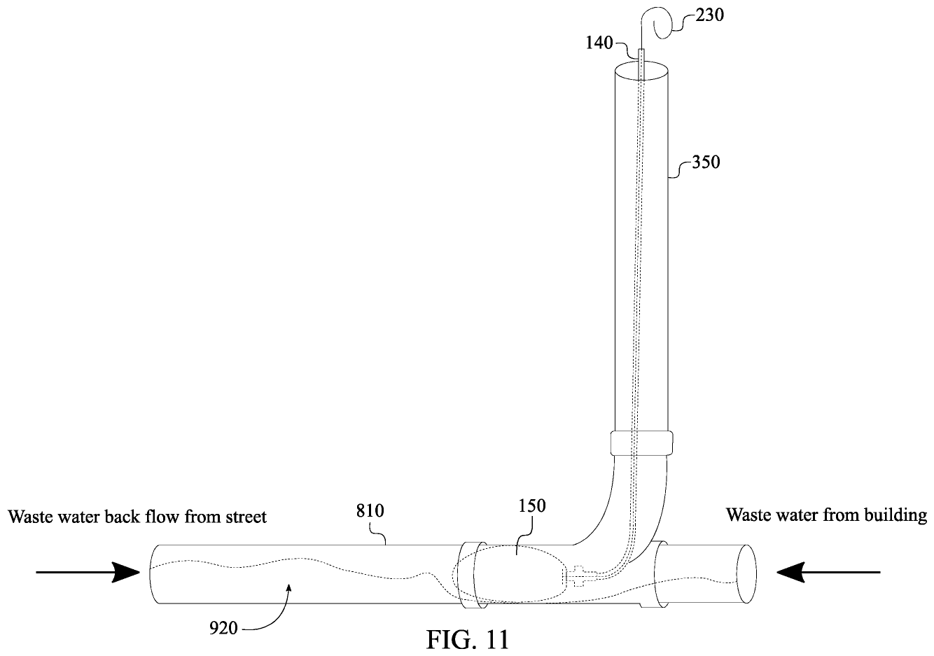

Unless otherwise specifically noted, articles depicted in the drawings are not necessarily drawn to scale.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “dorsal” refers to positions that are located near, on, or towards the upper or top side of a structure.

The present disclosure includes many aspects and features. Moreover, while many aspects and features relate to, and are described in the context of detection of presence of one or more intruder devices., embodiments of the present disclosure are not limited to use only in this context.

Embodiments disclosed herein seek to provide emergency backflow preventing systems, generally 100. Sewer systems contain pipes that provide a way to remove waste and contaminated water from residential dwellings and businesses. During hurricanes, storm surge, rainstorms, floods and other emergencies, or at times that high liquid volumes are introduced into the environment, the sewer systems can become overwhelmed and backed up, which causes the wastewater to flow back through the pipes into homes and businesses. Back flow can cause costly damage and result in serious health concerns (e.g., black mold).

Backflow arises when raw sewage and storm drainage use the same pipeline. For example, heavy rainfall, a storm surge or flooding may overload the system and thereby cause wastewater to flow back into homes and businesses. Solutions known in the art are typically non-leakproof, difficult to install, costly, difficult to maintain, lack the structural integrity to withstand heavy pressure, and fail to convey the presence of a clogged pipe or backflow situation.

Prior art addressing backflow issues include duckbill valve designs that use a shaped rubber member that closes on itself similar to lips that fold to close. The difference in thickness of the lips of the valve cause the lips to close and thereby form a seal that is not completely leak proof at extreme pressures. Duckbill valves are typically difficult to clean because the bottom of the valve is not mounted to the pipe and a cleaning snake would snag on the valve and possibly damage it. Even more, failure to attach the bottom lip to the pipe can result in the valve turning inside out under extreme pressure.

The instant disclosure seeks to provide a low-cost temporary emergency backflow preventing system that is easy to rapidly install, is leak-proof, powerless, and can be installed either inside or outside of a building. The system protects homes and businesses from backflow containing harmful liquids, gases and dangerous pathogens.

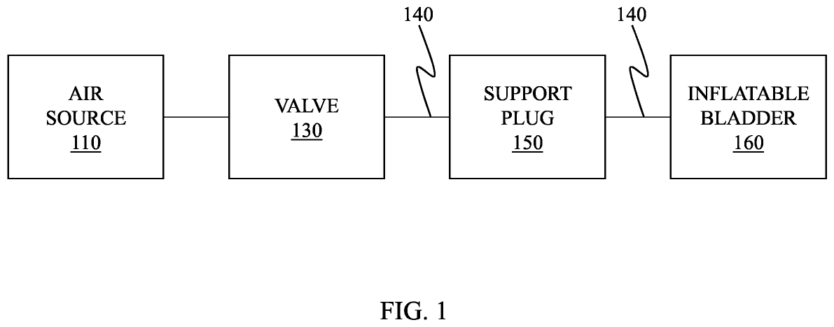

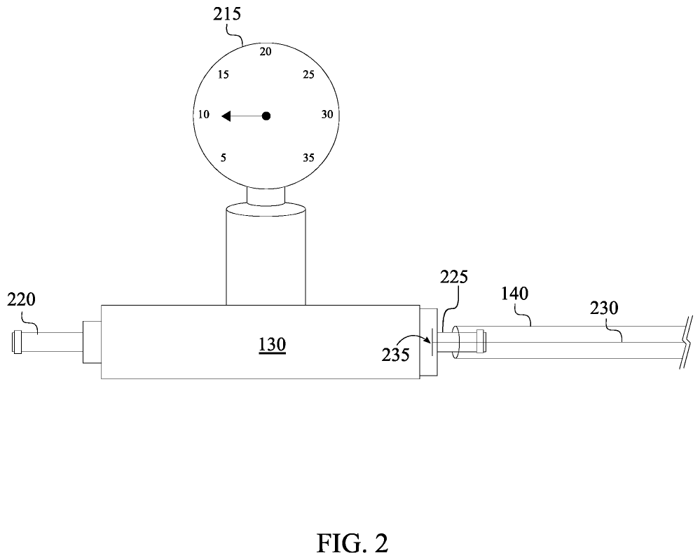

FIG. 1 depicts an emergency backflow preventing system (EBPS), generally 100, according to preferred embodiments. EBPS 100 includes air source 110, air supply line 120, valve 130, air supply line 140, support plug 150, and inflatable bladder 160. The air source 110 is coupled to valve 130 via air supply line 120. The air source 110 is preferably a hand air pump (e.g., similar to a typical bicycle pump) that includes the air supply line 120. The valve 130 is further coupled to inflatable bladder 160 via air supply line 140. FIG. 2 depicts the valve 130 coupled to the air supply line 140, according to preferred embodiments. The valve 130 includes Schrader valve 220, air pressure gauge 215, and port 225. The port 225 is demountably coupled to air supply line 140. Safety cable 230 is a metal and/or polymer cable, string, rope, or cord that initiates anchored within the valve 130, internally traverses the air supply line 140, and terminates internally anchored to the inflatable bladder 160.

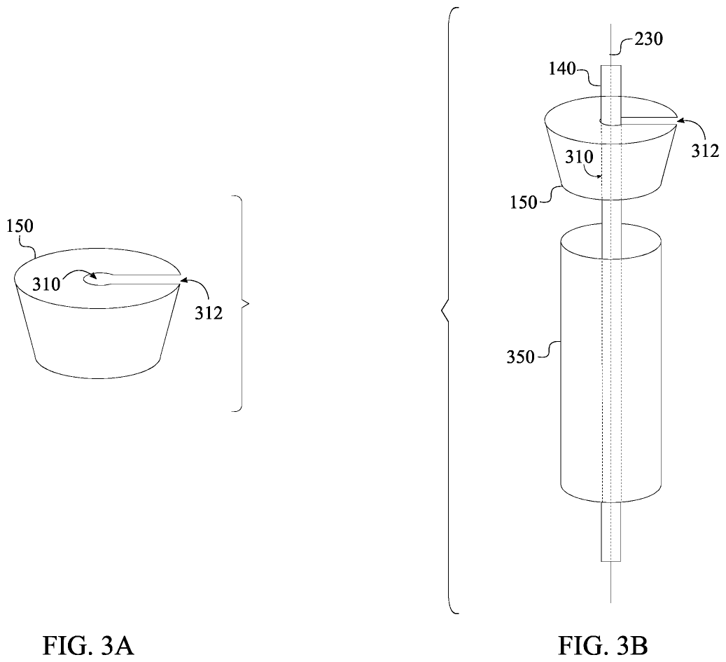

The Schrader valve 220 is preferably a typical Schrader valve known in the art that includes a valve stem into which a valve core is threaded. The valve core is a poppet valve assisted by a spring. A small rubber seal is located on the core that keeps the fluid from escaping through the threads. The Schrader valve 220 allows the inflatable bladder 160 receive and dissipate air (discussed further below). The air pressure gauge 215 is a device that quantifies the air pressure of the inflatable bladder 160. For example, the air pressure gauge 215 is configured to notify the user of over pressure, over inflation, and/or possible pipe damage (e.g., to the overflow pipe 350 and/or the sewer lateral 810). The port 225 is a passage that allows air fluid to pass through the valve 130. FIG. 3A depicts a perspective view of the support plug 150, according to preferred embodiments.

During storm surges, the support plug 150 is positioned wedge-like within the clean out pipe 350 to prevent outside groundwater from entering the building through the clean out pipe when uncapped. The support plug 150 is rotatably and demountably coupled to the air supply line 140. The support plug 150 preferably has a trapezoidal cross-section that provides a wedge-like interfitting when the support plug 150 is at least partially positioned within outside sewer clean out pipe (“sewage pipe”) 350. The support plug 150 is preferably made of a polymeric foam material. The support plug 150 preferably include an orifice 310 positioned adjacent to a slot 312 each traversing the width of the support plug 150. According to preferred embodiments, the slot 312 extends from the lateral surface of the support plug 150 to the orifice 310. The support plug 150 receives the air supply line 140 via the slot 312 and the orifice 310.

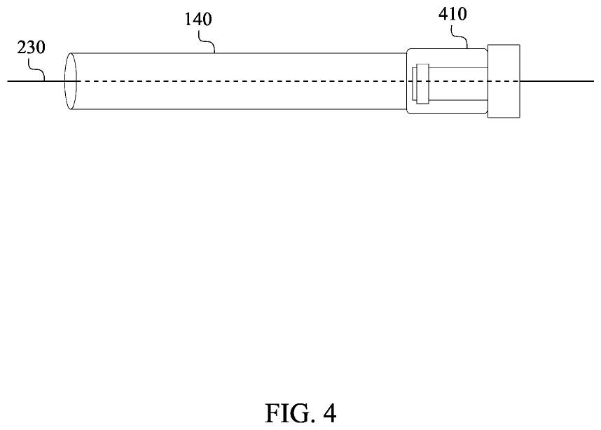

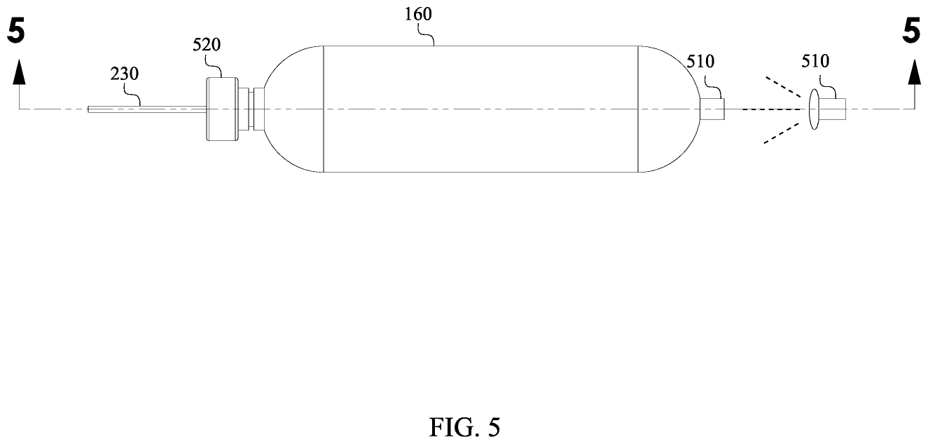

FIG. 4 depicts the safety cable 230 traversing the air supply line 140. Here, the air supply line 140 terminate at air bladder connection link 410. The air bladder connection link 410 is preferably a quick connect air coupling component that mates with air bladder connection link 520. FIG. 5 is a side view of inflatable bladder 160. The inflatable bladder 160 is preferably made of an elastic polymer (e.g., rubber). The inflatable bladder 160 is affixed to air bladder connection link 520 and receives air thereby. The air bladder connection link 520 is preferably a quick connect air coupling component that mates with air bladder connection link 410. In other words, air bladder connection links 410 and 520 together form a demountable fastener that demountably couples the air supply line 140 and the inflatable bladder 160. The inflatable bladder 160 can rupture when over pressurized (e.g., when the air pressure of the inflatable bladder 160 is greater than a threshold pressure). The inflatable bladder 160 is selectively plugged at orifice 610 to reduce over pressurization according to preferred embodiments.

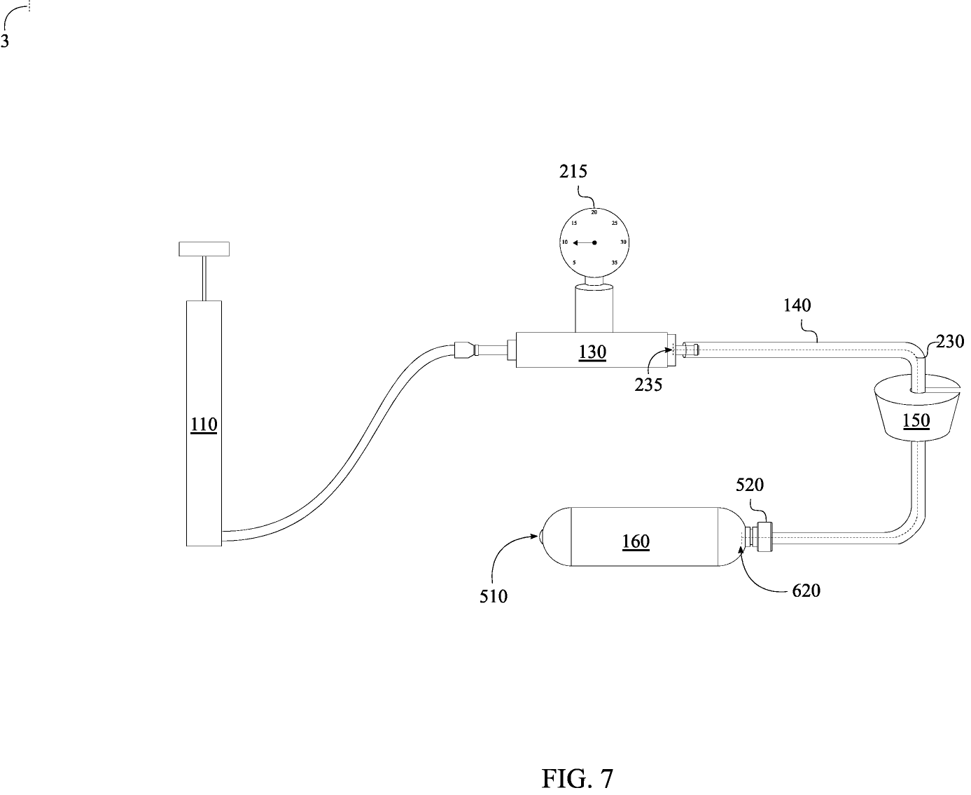

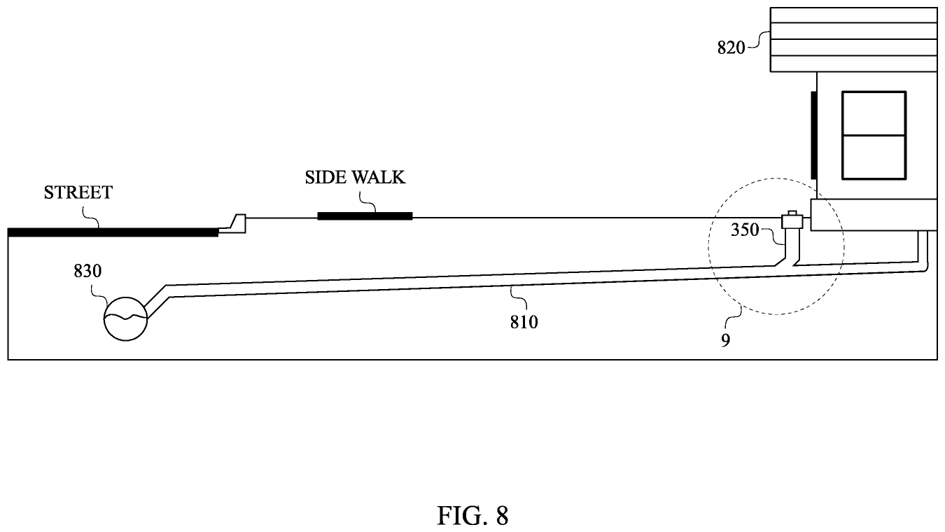

The overall structure of the plug 510 complements the orifice 610 allows it to remain in position until the inflatable bladder 160 reaches a threshold pressure that thereby ejects the plug 510 from the orifice 610. FIG. 7 depicts an assembled view of the EBPS 100, according to some embodiments. FIG. 8 illustrates a partial underground public utility view of building 820, in accordance with preferred embodiments. The building 820 is a residential and/or commercial structure that is connected to sewer main line 830 via sewer lateral 810. The sewer main line 830 is a typical large-diameter pipe that carries waste from every sink, toilet, floor drains, and showers in the building 820, through branch drains that connect into it. The sewer lateral 810 is a pipe typically used by a municipal sewage department to transit waste from a structure (e.g., the building 820) to the sewer (e.g., the sewer main line 830). The clean out pipe 350 is functionally coupled to sewer lateral 810 and provides the EBPS 100 access thereto.

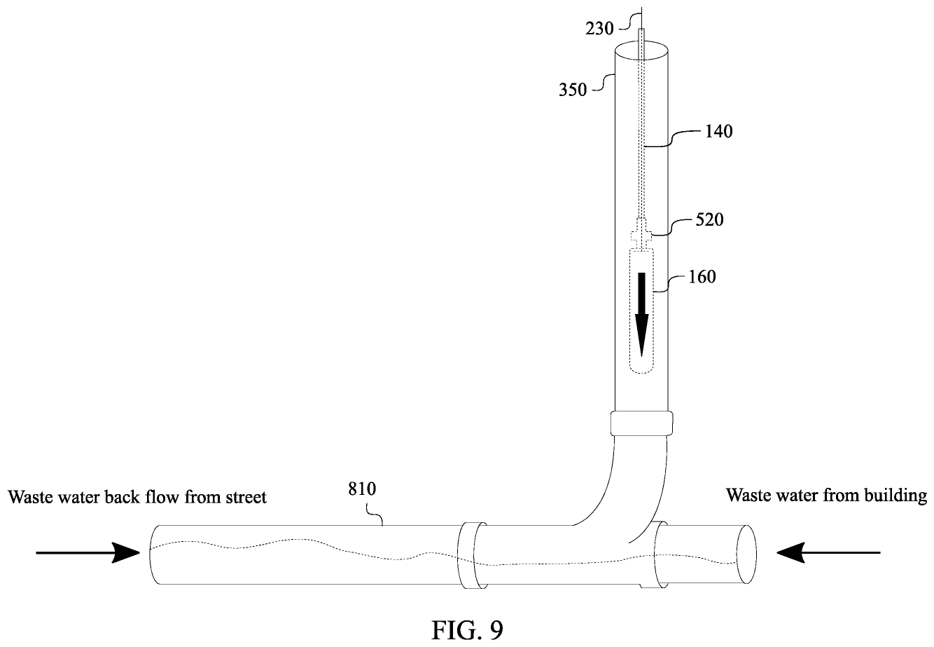

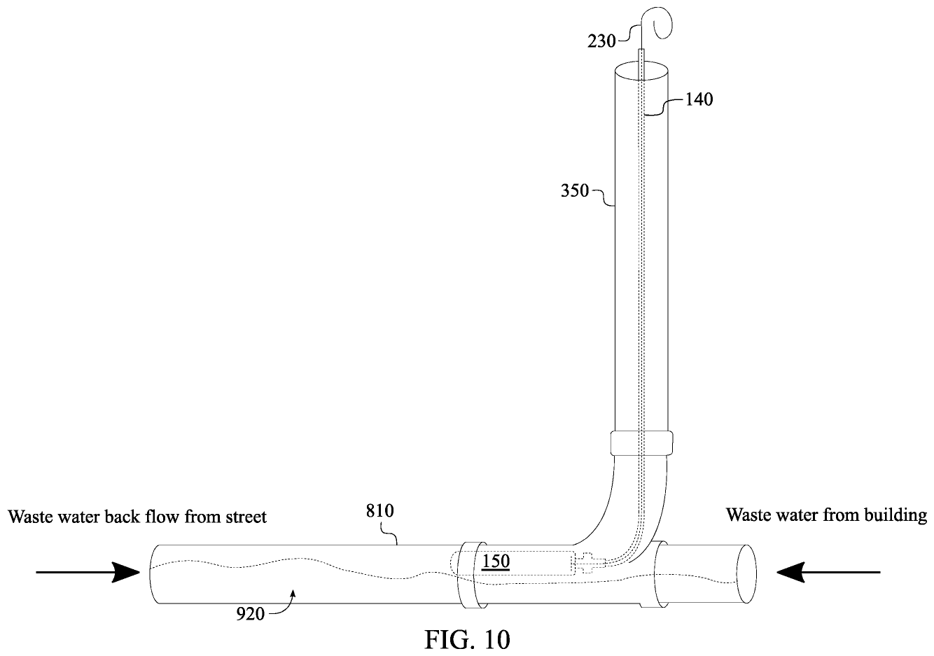

FIG. 9 is an illustration of View 9 of FIG. 8, according to some embodiments. View 9 depicts wastewater 920 backflow from the sewer main line 830 towards the building 820. Here, the inflatable bladder 160 is preferably inserted in to the clean out pipe 350 in its “deflated state.” As used herein, the “deflated state” refers to a depressurized condition of the inflatable bladder 160 where it contains little to no air and assumes its minimum length and/or circumference. In other words, the “deflated state” is any structure of the inflatable bladder 160 that allows its insertion and traversal of sewer lateral 810. As reflected in FIG. 10, the deflatable bladder 160 is preferably inserted into the sewer lateral 810 in its “deflated state”.

When the inflatable bladder 160 is positioned at the desired location within the sewer lateral 810, the air source 110 is activated to pressurize the inflatable bladder 160 and thereby cause it to transition to its “inflated” state. As used herein, the “inflated” state refers a pressurized condition of the inflatable bladder 160 where it contains sufficient air pressure to expand and assume a circumference that complements the bore of the sewer lateral 810. In other words, the “inflated state” is any structure of the inflatable bladder 160 that allows it to become wedged within the bore of the sewer lateral 810. Here, when the inflatable bladder 160 is in the “inflated state”, it creates a leak-proof seal within the sewer lateral 810 and thereby retards the ability of wastewater 920 to backflow. The plug 510 is configured to detach from the orifice 610 when the inflatable bladder 160 is in the “inflated state” and becomes over pressurized.

The inflatable bladder 160 is depressurized to assume its “deflated state” prior to its removal from the sewer lateral 810. Retrieval of the inflatable bladder 160 from the sewer lateral 810 is facilitated by the cable 230, which is anchored therein. Hence, removal of the cable 230 and the air supply line 140 from both the sewer lateral 810 and the clean out pipe 350 also ensures the removal of the inflatable bladder 160 therefrom.

Although the disclosure has been explained in relation to its preferred embodiment, it is to be understood that many other possible modifications and variations can be made without departing from the spirit and scope of the disclosure.

What is claimed is:

1. An emergency backflow preventing system, the system comprising:
an inflatable bladder;
an air supply line demountably coupled to the inflatable bladder;
a valve demountably coupled to the air supply line;
an air source functionally coupled to the valve;
wherein the inflatable bladder
comprises a deflated state and an inflated state;
is substantially void of air in the deflated state;
the inflatable bladder is configured to be inserted within a sewage pipe when in the deflated state;
the inflatable bladder is configured to contact a bore of the sewage pipe when in the inflated state and thereby wedge itself within the sewage pipe;
the inflatable bladder comprises an elastic polymer; and
the valve comprises a Schrader valve.

2. The system of claim 1, wherein the valve comprises an air pressure gauge.

3. The system of claim 2, further comprising:
a cable positioned within the air supply line; and
wherein the cable is anchored within the valve and within the inflatable bladder.

4. The system of claim 3, wherein
the inflatable bladder comprises an orifice and a plug; and
the plug is positioned within the orifice and thereby seals the orifice.

5. The system of claim 4, wherein the plug is configured to detach from the orifice when the inflatable bladder is in the inflated stated and comprises a pressure greater than a threshold amount.

6. The system of claim 5, further comprising:
a support plug rotatably and demountably coupled to the air supply line;
wherein
the support plug comprises a trapezoidal cross-section; and
the trapezoidal cross-section is configured to provide a wedge-like interfitting when the support plug is at least partially positioned within the sewage pipe.

7. The system of claim 6, wherein the support plug comprises a polymeric foam.

8. The system of claim 7, wherein the air supply line is demountably coupled to the inflatable bladder via a demountable fastener.

9. An emergency backflow preventing system, the system comprising:
an inflatable bladder;
an air supply line demountably coupled to the inflatable bladder;
a valve demountably coupled to the air supply line;
an air source functionally coupled to the valve;
wherein the inflatable bladder
comprises a deflated state and an inflated state;
is substantially void of air in the deflated state;
the inflatable bladder is configured to be inserted within a sewage pipe when in the deflated state;
the inflatable bladder is configured to contact a bore of the sewage pipe when in the inflated state and thereby wedge itself within the sewage pipe;
the inflatable bladder comprises an elastic polymer; and
wherein the valve comprises a Schrader valve and an air pressure gauge.

10. The system of claim 9, further comprising:
a cable positioned within the air supply line; and
wherein the cable is anchored within the valve and within the inflatable bladder.

11. The system of claim 10, wherein
the inflatable bladder comprises an orifice and a plug; and
the plug is positioned within the orifice and thereby seals the orifice.

12. The system of claim 11, wherein the plug is configured to detach from the orifice when the inflatable bladder is in the inflated stated and comprises a pressure greater than a threshold amount.

13. The system of claim 12, further comprising:
a support plug rotatably and demountably coupled to the air supply line;
wherein
the support plug comprises a trapezoidal cross-section; and
the trapezoidal cross-section is configured to provide a wedge-like interfitting when the support plug is at least partially positioned within the sewage pipe.

14. The system of claim 13, wherein the support plug comprises a polymeric foam material.

15. The system of claim 14, wherein the air supply line is demountably coupled to the inflatable bladder via a demountable fastener.

16. An emergency backflow preventing system, the system comprising:
an inflatable bladder;
an air supply line demountably coupled to the inflatable bladder;
a valve demountably coupled to the air supply line;
an air source functionally coupled to the valve;
a cable positioned within the air supply line;
wherein
the inflatable bladder
comprises a deflated state and an inflated state;
is substantially void of air in the deflated state;
is configured to be inserted within a sewage pipe when in the deflated state;
is configured to contact a bore of the sewage pipe when in the inflated state and thereby wedge itself within the sewage pipe;
comprises an elastic polymer;
wherein the valve comprises
a Schrader valve; and
an air pressure gauge.

17. The system of claim 16, wherein
the inflatable bladder comprises an orifice and a plug; and
the plug is positioned within the orifice and thereby seals the orifice.

18. The system of claim 17, further comprising:
a support plug rotatably and demountably coupled to the air supply line;
wherein
the support plug comprises a trapezoidal cross-section;
the trapezoidal cross-section is configured to provide a wedge-like interfitting when the support plug is at least partially positioned within the sewage pipe; and
the support plug is configured to detach from the orifice when the inflatable bladder is in the inflated stated and comprises a pressure greater than a threshold amount.

19. The system of claim 18, wherein the support plug comprises a polymeric foam material.

20. The system of claim 19, wherein the air supply line is demountably coupled to the inflatable bladder via a demountable fastener.
